(19) United States
(12) Patent Application Publication
(10) Pub. No.: US 2005/0124294 A1
(43) Pub. Date: Jun. 9, 2005

(54) Wireless access point simultaneously supporting basic service sets on multiple channels

(75) Inventor: Menzo Wentink, Utrecht (NL)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Conextant Systems, Inc., Red Bank, NJ (US)

(21) Appl. No.: 10/989,289

(22) Filed: Nov. 17, 2004

Related U.S. Application Data
(60) Provisional application No. 60/520,365, filed on Nov. 17, 2003.

(51) Int. Cl. H04B 7/00

(52) U.S. Cl. 455/41.2

(57) ABSTRACT

The present invention provides a technique for an access point (AP) to maintain a basic service set (BSS) on two or more channels simultaneously by temporarily blocking one BSS and servicing the other BSS while the other BSS is blocked, thereby providing an efficient way to create a dual cell AP with only a single radio. In an embodiment of the invention, a method for servicing a first set of wireless stations operating on a first channel of an access point and a second set of wireless stations operating on a second channel of the access point comprises transmitting, at a first time, a first frame from the access point to the first set of wireless stations via the first channel, the first frame having duration data directing the first set of wireless stations to cease transmitting until a second time represented by the duration data and servicing the second set of wireless stations via the second channel of the access point for at least a part of a time period between the first time and the second time. The method further comprises transmitting, at the second time, a second frame from the access point to the second set of wireless stations via the second channel, the second frame having duration data directing the second set of wireless stations to cease transmitting until a third time represented by the duration data of the second frame and servicing the first set of wireless stations via the first channel of the access point for at least a part of a time period between the second time and the third time. The method also may comprise transmitting a Delivery Transmission Indication Map (DTIM) frame prior to transmitting each of the first and second frames. The transmission of the DTIM frame preferably occurs substantially simultaneously with a Target Beacon Transmission Time (TBTT) of the access point.

### CROSS-REFERENCE TO RELATED APPLICATIONS

The present application claims priority to U.S. Provisional Patent Application No. 60/520,365, filed Nov. 17, 2004, and entitled “Wireless Access Point Simultaneously Supporting Basic Service Sets On Multiple Channels,” the disclosure of which is hereby incorporated by reference in its entirety.

### BACKGROUND OF THE INVENTION

1. Field of the Invention

The present invention relates generally to wireless networking and more particularly to a technique for providing multiple basic service sets using a single access point.

2. Description of Related Art

Various wireless standards, such as Institute of Electrical and Electronics Engineers (IEEE) standards 802.11a/b/c/e/g/i (referred to collectively as IEEE 802.11), provide for wireless connectivity between wireless stations and an infrastructure network (e.g., the Internet) via an access point. Processes covered by these standards include the association of a wireless station with an access point, the transmission of data from a wireless station to the infrastructure network, and vice versa, via the access point, communication between wireless stations via an access point, and the like.

In accordance with the IEEE 802.11 standards, wireless stations serviced by an access point typically are associated with a Basic Service Set (BSS), analogous to a subnetwork, where each BSS is assigned a unique BSS identification number (BSSID). Communications between stations within a given BSS and communications between a station and a wired network infrastructure are communicated via the access point as an intermediary. For example, to transmit a frame from a first station of a BSS to a second station of the BSS, the first station transmits the frame to the access point responsible for the BSS. After modifying the header of the frame as appropriate, the access point then forwards the frame to the second station.

In some instances, it is advantageous to use an access point with a single radio to support multiple BSSs on different channels simultaneously. For example, one BSS could be residing in the 2.4 GHz band, thereby supporting 802.11g-compliant stations, while the second BSS resides in the 5 GHz band, thereby supporting 802.11a-compliant stations. Thus, by using two radios, both types of stations can join with the same access point, even though the stations are limited to operation in different, non-overlapping bands. The use of a multiple-radio access point therefore saves cost in setting up a wireless network infrastructure that allows multiple types of stations to join. A conventional technique developed to support multiple BSSs for a single access point implements multiple channels, each channel corresponding to a different BSS. This technique requires the use of an access point having multiple radios (i.e., multiple transmitters or “PHYs”), where each radio supports a different channel. A major problem with multiple-radio access points is the added complexity and cost of their implementation due to the dual parallel transmission pathways that must exist in such access points.

Accordingly, a technique for supporting multiple BSSs using a single-radio access point would be advantageous.

### SUMMARY OF THE INVENTION

The present invention overcomes these and other deficiencies of the related art by providing a technique for an access point (AP) to maintain a basic service set (BSS) on two or more channels simultaneously by temporarily blocking one BSS and servicing the other BSS while the other BSS is blocked, thereby providing an efficient way to create a dual cell AP with only a single radio.

The present invention capitalizes on the fact that stations in a BSS typically listen for Delivery Traffic Indication Map (DTIM) beacons, which are transmitted at or shortly after the DTIM Target Beacon Transmission Time (herein referred to as “TBTT”), whether they are in sleep mode or not. At the TBTT, the access point precedes the DTIM Beacon with a blocking frame that contains a suitable value in the Duration/ID field of the Media Access Control (MAC) header. This value sets a virtual carrier sense in all clients associated to that BSS, which effectively blocks all uplink traffic in that BSS for the prescribed period. The blocking frame may include, for example, a Clear-to-Send (CTS) frame addressed at the AP (CTS-to-self), with a Duration/ID field value which corresponds with the planned service duration of the other BSS. The transmission of another type of frame may be used as appropriate, such as a Null frame. The value in the Duration/ID field of the CTS frame is copied by the stations into their Network Allocation Vector (NAV), which counts down to 0 from the copied value. A non-zero NAV indicates that the virtual carrier sense is active, which implies that stations will hold their transmissions, by virtue of the fact that these stations adhere to the listen-before-talk paradigm, which is also referred to as Carrier Sense Multiple Access/Collision Avoidance (CSMA/CA). After having set the NAV in a first BSS, the AP continues with transmitting downlink traffic in that BSS (such as, for example, broadcast/multicast (BC/MC) and unicast frames, if any are queued and if sufficient time remains), after which it switches to a second BSS, where the NAV is about to end, and starts servicing that channel. The service period for the second BSS ends at the TBTT for that BSS, at which time the AP transmits a CTS-to-self, the DTIM beacon and possible downlink traffic and switches back to the first BSS, where the NAV, in turn, is about to end.

In accordance with at least one embodiment of the invention, a method of maintaining a basic service set on two or more channels simultaneously in a communications network comprising a first set of stations associated with a first basic service set and a second set of stations associated with a second basic service set, comprises the steps of: blocking, for a first period of time, transmission of a first set of stations associated with a first basic service set, and servicing, for a portion of the first period of time, a second set of stations associated with a second basic service set. The method further comprises the steps of: blocking, for a second period of time, transmission of the second set of stations associated with the second basic service set, and servicing, for a portion of the second period of time, the first set of stations associated with the first basic service set. The first period of time can be defined by a synchronization signal, particularly a beacon period of an IEEE 802.11-based wireless network. The method can further comprise the step of switching from a first communications channel of the first set of stations to a second communications channel of the second set of stations, wherein the first and second communications channels operate at different frequencies. The step of blocking can comprise the step of transmitting a signal to the first set of stations to cause the first set of stations to enter into a virtual carrier sense mode for a duration of time. The signal can comprise a value representing a length of the first period of time. The transmission of the first set of stations can occur at a 2.4 GHz band and the transmission of the second set of stations can occur at a 5 GHz band.

In accordance with at least one embodiment of the invention, an access point comprises: a transceiver capable of operating at two or more radio frequency channels, and a signal generator for generating a beacon frame signal. Each of the two or more radio frequency channels is associated with a unique basic service set. A controller can be included to switch the transceiver from one channel to another at a time dependent on an occurrence of the beacon frame signal. The two or more radio frequencies are each based on an IEEE 802.11 protocol.

In accordance with at least one embodiment of the present invention, a method for servicing a first set of wireless stations operating on a first channel of an access point and a second set of wireless stations operating on a second channel of the access point is provided. The method comprises transmitting, at a first time, a first frame from the access point to the first set of wireless stations via the first channel, the first frame having duration data directing the first set of wireless stations to cease transmitting until a second time represented by the duration data and servicing the second set of wireless stations via the second channel of the access point for at least a part of a time period between the first time and the second time. The method further comprises transmitting, at the second time, a second frame from the access point to the second set of wireless stations via the second channel, the second frame having duration data directing the second set of wireless stations to cease transmitting until a third time represented by the duration data of the second frame and servicing the first set of wireless stations via the first channel of the access point for at least a part of a time period between the second time and the third time. The method also may comprise transmitting a Delivery Transmission Indication Map (DTIM) frame prior to transmitting each of the first and second frames. The transmission of the DTIM frame preferably occurs substantially simultaneously with a Target Beacon Transmission Time (TBTT) of the access point.

In a wireless network, an access point is provided in accordance with another embodiment of the present invention. The access point comprises means for communicating with a first set of wireless stations via a first channel, means for communicating with a second set of wireless stations via a second channel, means for transmitting a first frame to the first set of wireless stations via the first channel at a first time, the first frame having duration data directing the first set of wireless stations to cease transmitting until a second time represented by the duration data of the first frame and means for transmitting a second frame to the second set of wireless stations via the second channel at a second time, the second frame having duration data directing the second set of wireless stations to cease transmitting until a third time represented by the duration data of the second frame. The access point is adapted to service the second set of wireless stations via the second channel of the access point for at least a part of a time period between the first time and the second time and service the first set of wireless stations via the first channel of the access point for at least a part of a time period between the second time and the third time. The access point further may comprise means for transmitting a Delivery Transmission Indication Map (DTIM) frame prior to transmitting each of the first and second frames, wherein the transmission of the DTIM frame preferably occurs substantially simultaneously with a Target Beacon Transmission Time (TBTT) of the access point.

The present invention mitigates or solves the above-identified limitations in known solutions, as well as other unspecified deficiencies in known solutions. A number of advantages associated with the present invention are readily evident to those of ordinary skill in the art, including economy of design and resources, transparent operation, cost savings, etc.

The foregoing, and other features and advantages of the invention, will be apparent from the following, more particular description of the invention, the accompanying drawings, and the claims.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a multiple BSS system comprising a plurality of wireless stations associated with a single-radio access point according to an embodiment of the invention;

FIG. 2 illustrates operation of the access point within the multiple BSS system of FIG. 1 according to an embodiment of the invention;

FIG. 3 illustrates operation of the wireless stations within the multiple BSS system of FIG. 1 according to an embodiment of the invention;

FIG. 4 illustrates exemplary sequential processing within the multiple BSS system of FIG. 1 according to an embodiment of the invention;

FIG. 5 illustrates exemplary operation of the multiple BSS system of FIG. 1 according to another embodiment of the invention;

FIG. 6 illustrates exemplary operation of the multiple BSS system of FIG. 1 according to yet another embodiment of the invention; and

FIG. 7 illustrates exemplary operation of the multiple BSS system of FIG. 1 according to yet another embodiment of the invention.

### DETAILED DESCRIPTION OF THE INVENTION

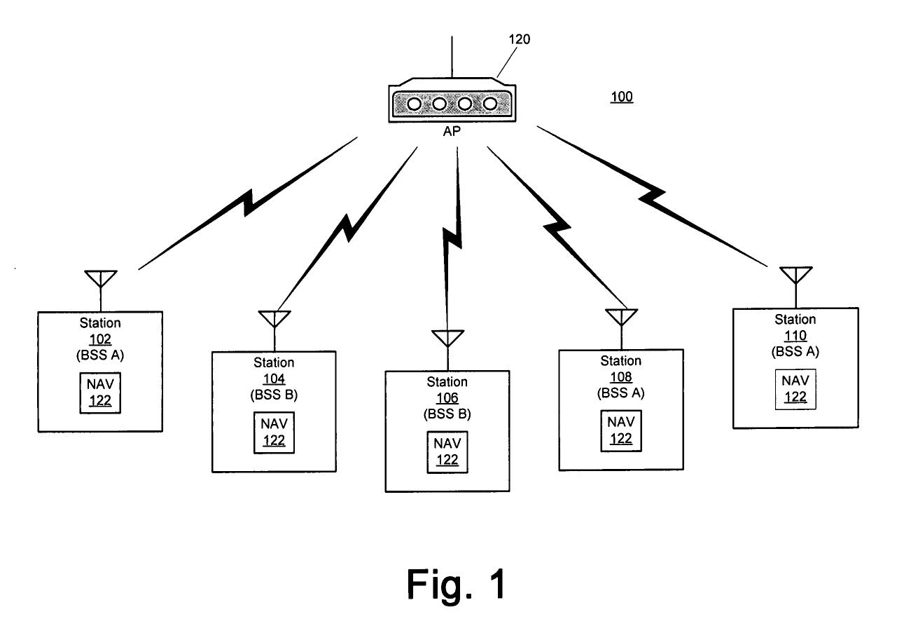

The present invention and its advantages may be understood by referring to FIGS. 1-7, which describes exemplary techniques for supporting multiple Basic Service Sets (BSS) using a single-radio access point (AP). For ease of illustration, the various techniques of the present invention are discussed below in the context of IEEE 802.11-based wireless networking. However, those of one of ordinary skill in the art, using the teachings provided herein, may advantageously implement the disclosed techniques in other wireless networks. Accordingly, references to techniques and components specific to IEEE 802.11 apply also to the equivalent techniques or components in other wireless network standards unless otherwise noted.

FIG. 1 illustrates an exemplary multiple BSS system 100 comprising a plurality of wireless stations 102-110 associated with a single-radio access point 120 according to an embodiment of the invention. Stations 102, 108 and 110 are associated with a first Basic Service Set (e.g., BSS A) on a channel A and stations 104 and 106 are associated with a second Basic Service Set (e.g., BSS B) on a channel B. The wireless stations 102-110 include devices enabled to communicate wirelessly using one or more protocols supported by the access point 120. Such protocols may include, for example, the IEEE 802.11 protocols (802.11a/b/e/g/i), and the like. Examples of wireless-enabled devices may include notebook (or “laptop”) computers, PC cards, handheld computers, desktop computers, workstations, servers, portable digital assistants (PDAs), mobile or cellular phones, etc.

Wireless networks typically implement one or more synchronization processes to ensure coordination between the members of the network. To illustrate, IEEE 802.11 provides for the transmission of beacon frames so that the wireless stations receiving the beacon frames may synchronize based on the beacon. Beacons frames are supposed to be transmitted at the end of each beacon interval, where the intended time of transmission of the beacon is commonly referred to as the target beacon transmission time (TBTT).

In infrastructure networks, the access point is responsible for transmitting the beacon at the TBTT. Accordingly, the wireless stations within the BSS track the beacon period and cease transmission as the TBTT approaches in anticipation of a traffic indication map (TIM) frame that is used by the wireless stations to receive frames buffered at the access point while the wireless stations are in power-saving mode. Every certain number of beacon intervals (e.g., every three beacon intervals), a delivery TIM (DTIM) frame is transmitted by the access point at or near the TBTT. The DTIM frame is used to alert the wireless stations that the access point is about to transmit one or more multicast or broadcast frames buffered at the access point and to alert specific power save stations that unicast data is buffered at the access point.

IEEE 802.11 compliant wireless networks typically employ carrier sense multiple access with collision avoidance (CSMA/CA) to determine if the medium (i.e., the assigned RF frequencies) are available for the transmission of data. As physical carrier sensing is difficult to properly implement in wireless networks, virtual carrier sensing typically is used to prevent the simultaneous transmission by two or more wireless devices. Virtual carrier sensing typically is employed by using a timer, commonly referred to as a network allocation vector (NAV) (i.e., NAV 122), maintained at the wireless stations 102-110. Most frames include a duration field used to reserve the RF medium for a time period defined by the duration field. Upon receipt of a frame having a duration field, a wireless station sets its NAV to the value in the duration field, starts the countdown of the NAV, and holds off on transmitting frames until the NAV counts down to zero. Thus, the wireless station interprets a non-zero NAV as an indication that the RF medium is busy and interprets a zero-valued NAV as an indication that the RF medium is idle and the wireless station therefore may request to transmit data on the RF medium.

The access point 120 can be adapted to utilize the above-described synchronization and CSMA/CA processes to support multiple BSSs on separate channels without requiring multiple radios.

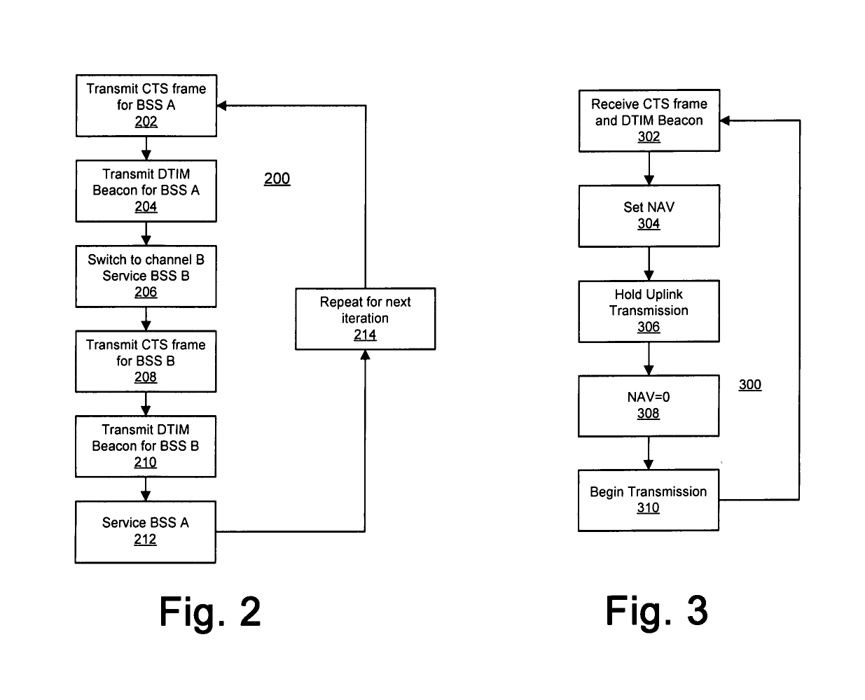

To illustrate, FIG. 2 depicts multiple BSS operation 200 of the access point 120 according to an exemplary embodiment of the invention. The operation 200 initiates at step 202 wherein the access point 120, at or near an iteration of the TBTT, transmits a frame to the wireless stations 102, 108 and 110 of BSS A, where the frame comprises an appropriate value in the duration field of the media access control (MAC) header of the frame. The value in the duration field preferably is related to the length of the beacon period (i.e., the time between TBTTs). In a preferred embodiment, the frame includes a clear-to-send (CTS) frame addressed to the access point (i.e., CTS-to-self). As discussed in further detail below, the value in the duration field sets the wireless stations 102, 108 and 110 into virtual carrier sense mode whereby all uplink traffic in BSS A is effectively blocked as the wireless stations 102, 108 and 110 prevent themselves from transmitting while in virtual carrier sense mode. At step 204, the access point 120 transmits a DTIM frame to the wireless stations 102, 108 and 110, possibly followed by more downlink traffic, including BC/MC traffic.

While the stations 102, 108 and 110 are blocked from transmitting on channel A, the access point 120 switches to channel B at step 206 and services the uplink and downlink traffic associated with the stations 104 and 106 of BSS B. The access point 120 can continue to service the stations 104 and 106 of BSS B until the next TBTT approaches. When the next TBTT arrives, the access point 120 may transmit a frame (e.g., a CTS-to-self frame) to stations 104 and 106 of BSS B at step 208, where the frame has the appropriate value in the duration field. Upon receipt of this frame, the stations 104 and 106 enter the virtual carrier sense mode and cease transmitting for the period defined by the value in the duration field of the frame. Shortly after transmitting the frame in step 208, the access point transmits a DTIM beacon frame and possibly other downlink traffic, like broadcast and unicast (BC/MC) traffic to the stations 104 and 106 of BSS B at step 210.

Because the stations 104 and 106 are temporarily blocked from transmitting, the access point 120 may switch to channel A and service uplink and downlink traffic from stations 102, 108 and 110 of BSS A at step 212. The process of blocking transmission by stations of one BSS for a beacon period and servicing the stations of another BSS during the beacon period may be repeated at step 214.

Referring now to FIG. 3, an exemplary operation 300 of each of the stations 102-110 is illustrated according to an embodiment of the invention. Upon receipt of a CTS frame transmitted by the access point 120 at step 302, the stations 102-110 extract the value in the duration field of the CTS frame and set the NAV 122 using this value at step 304. As a value in the duration field of a frame indicates to a receiving station that the medium will be used for a time period represented by the value, the station enters the virtual carrier sense mode by starting the countdown of the NAV and holding all transmissions at step 306. While the NAV is non-zero, the station is blocked from transmitting. However, once the NAV counts down to zero at step 308, the station may exit from the virtual carrier sense mode and attempt to transmit at step 310. A back off procedure, the implementation of which is apparent to one of ordinary skill in the art, can be invoked whenever a station desires to transmit a message data unit and finds the channel busy, or when a higher priority queue within a station preempts transmission of a message data unit from a lower priority queue.

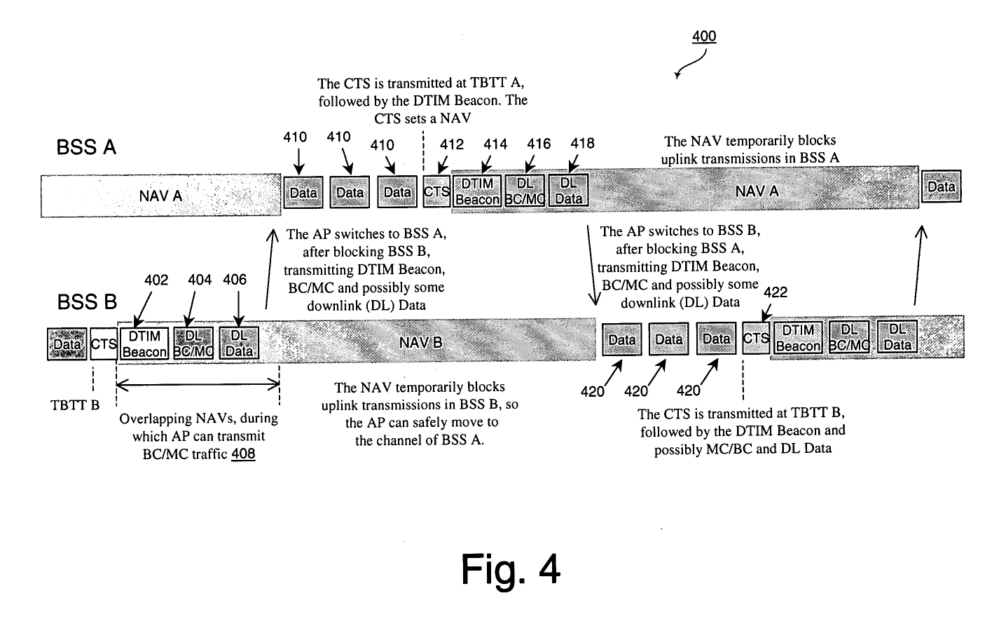

FIG. 4 illustrates exemplary operation of the multiple BSS system 100 using a sequential processing technique 400 according to an embodiment of the invention. Particularly, after transmission of a DTIM beacon 402, the access point 120 can transmit BC/MC downlink traffic 404 and possibly some downlink data 406 to the stations 104 and 106 of BSS B during the overlap period 408 of NAV A and NAV B. The access point 120 then switches to BSS A and services the uplink and downlink traffic 410 associated with the stations 102, 108 and 110 until the next TBTT arrives. At the TBTT, a CTS frame 412 is then transmitted by the access point 120 to set the NAV 122 in stations 102, 108, and 110. The NAV 122 temporarily blocks uplink transmission in BSS A. After the CTS frame 412, the access point 120 transmits a DTIM beacon 414, BC/MC downlink traffic 416 and possibly some downlink data 418 to the stations 102, 108 and 110 of BSS A. The access point 120 then switches to BSS B and services the uplink and downlink traffic 420 associated with the stations 104 and 106 of BSS B until the next TBTT arrives. At that TBTT, a CTS frame 422 is then transmitted by the access point 120 to set the NAV 122 in stations 104 and 106 of BSS B. The sequential processing is continuously repeated. Note that the overhead for sending the CTS and the DTIM beacon as suggested in the figure is exaggerated. In reality, the time for transmitting the CTS frame and the beacon will be negligible to the beacon period.

If the amount of BC/MC traffic is large and must be interrupted because the service on another BSS begins, the access point 120 may reset a More Data frame of the last BC/MC transmission, even if more frames are still queued. This allows power save stations to go back into the sleep state for the duration the access point 120 services another BSS. The access point continues the BC/MC transmissions after the next DTIM beacon on that BSS.

The duty cycle with which each BSS is serviced can be fixed, because the TBTTs are fixed. The access point 120 may determine the duty cycle at the time the second BSS is set up, but typically is prevented from changing it after that. A 50% duty cycle may be achieved by scheduling TBTT for a second BSS as halfway between TBTTs for a first BSS.

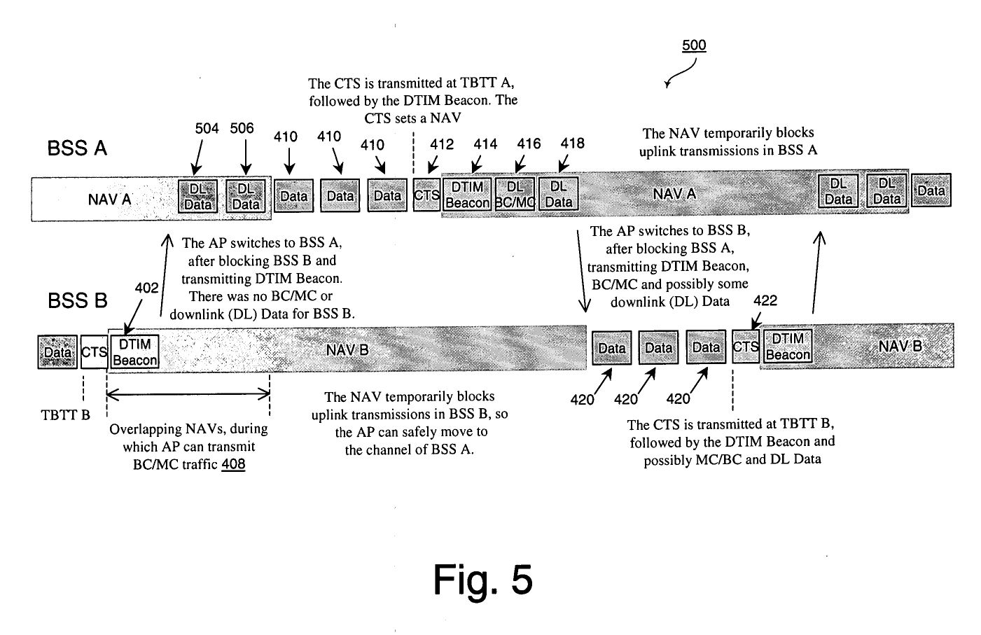

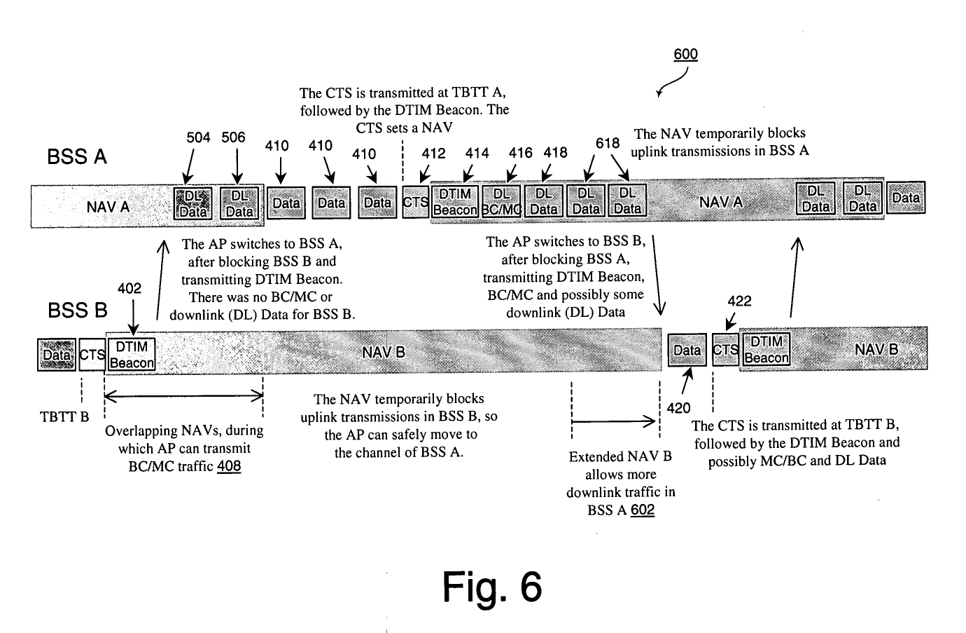

FIG. 5 illustrates exemplary operation of the multiple BSS system 100 using a sequential processing technique 500 according to another embodiment of the invention. Here, the access point 120 may switch early to BSS A to serve downlink traffic 504 and 506 for BSS A because there is no further downlink traffic for BSS B in this example. Note that the access point 120 can always transmit traffic on any BSS irrespective of whether a NAV is set in that BSS.

FIG. 6 illustrates exemplary operation of the multiple BSS system 100 using a sequential processing technique 600 according to another embodiment of the invention. Here, the access point 120 extends the NAV on BSS B at period 602 so that more downlink traffic data 618 can be served for BSS A. For instance, after each TBTT, a period may exist during which the NAV in the BSSs overlaps. This overlapping NAV period may be increased by the access point 120 to allow more downlink transmissions in one BSS (i.e., when the downlink traffic load is asymmetric across BSSs). The access point 120 may determine the increased overlapping NAV duration 602 on previous downlink traffic patterns or on the current internal queue status.

The NAV period set in the CTS frame preferably extends until after the TBTT on the other BSS, because it must incorporate the transmission of the CTS and the beacon, but must also incorporate a possible delayed transmission of the CTS and the Beacon on this channel, due to transmissions which exceed the TBTT. If the CTS and the Beacon are indeed transmitted at the TBTT and the access point 120 returns to the other BSS before the NAV has ended, this BSS will still be blocked. During this time, the access point 120 can start the downlink transmissions, while uplink transmissions will only be possible after the NAV has expired. In other words, an extended NAV setting does not necessarily introduce wasted time, because the access point can use this time for downlink transmissions.

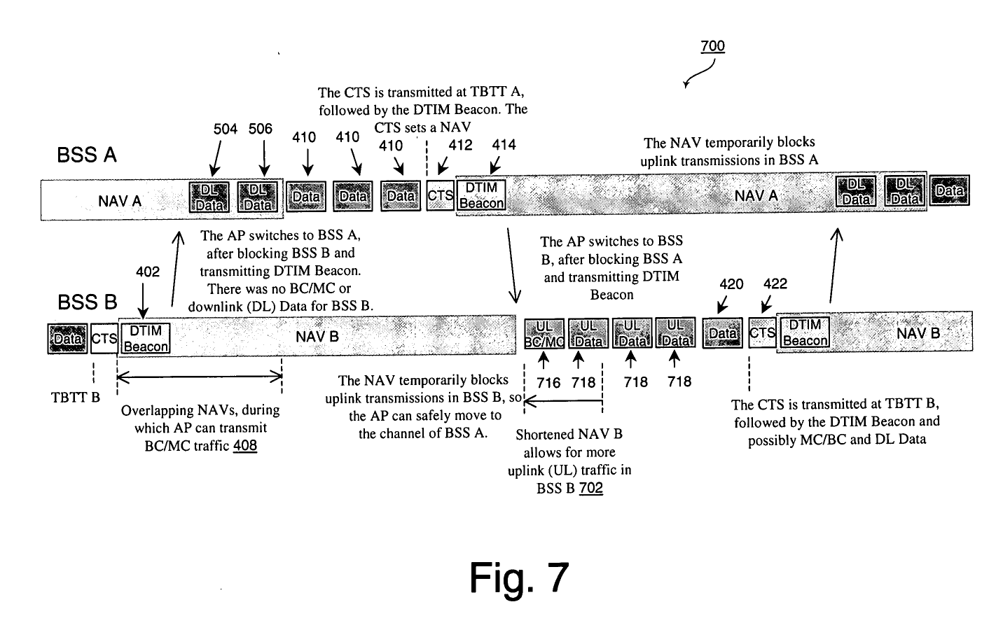

FIG. 7 illustrates exemplary operation of the multiple BSS system 100 using a sequential processing technique 700 according to another embodiment of the invention. In this case, the access point 120 shortens the NAV on BSS B at period 702 so that BC/MC uplink traffic 716 and/or more uplink traffic data 718 can be served for BSS B. For instance, the access point 120 may reduce the overlapping NAV period when one BSS has more uplink traffic than another (i.e., when the uplink traffic load is asymmetric across BSSs). The access point 120 may determine the shortened overlapping NAV period 702 on previous uplink traffic patterns, or on remote queue status which was piggybacked on uplink transmissions.

Due to the sequential nature of the BSS service periods, a transmission delay may be introduced which is equal to the time it takes to service the other BSS(es). This delay can be reduced by reducing the TBTT period, but at the cost of higher switching and beaconing overhead.

The CTS frame and the DTIM beacon preferably are separated by a SIFS period or other inter-frame period to prevent other stations from transmitting in between the CTS and the DTIM beacon, the implementation of which is apparent to one of ordinary skill in the art.

As the above description demonstrates, the access point 120 may service multiple BSSs on multiple channels by sequentially servicing the stations of each BSS on a certain channel while blocking the stations of the BSSs on other channels using the virtual carrier sense processes provided by conventional wireless standards. Although the present invention is described in the context of sequential processing of two basic service sets, one of ordinary skill in the art will recognize that three or more basic service sets can also be sequentially serviced by a single radio access point by implementing the inventive concepts described herein.

The preceding description is intended to convey a thorough understanding of the present invention by providing a number of specific embodiments and details involving the provision of multiple BSSs using a single-radio access point. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs. Although the invention has been particularly shown and described with reference to several exemplary embodiments thereof, it will be understood by those of ordinary skill in the art that various changes in form and details may be made therein without departing from the spirit and scope of the invention as defined in the appended claims.

1. A method of maintaining a basic service set on two or more channels simultaneously in a communications network comprising a first set of stations associated with a first basic service set and a second set of stations associated with a second basic service set, the method comprising the steps of:
blocking, for a first period of time, transmission of a first set of stations associated with a first basic service set, and
servicing, for a portion of said first period of time, a second set of stations associated with a second basic service set.

2. The method of claim 1, further comprising the steps of:
blocking, for a second period of time, transmission of said second set of stations associated with said second basic service set, and
servicing, for a portion of said second period of time, said first set of stations associated with said first basic service set.

3. The method of claim 1, wherein said first period of time is defined by a synchronization signal.

4. The method of claim 1, wherein said communications network is an IEEE 802.11-based wireless network.

5. The method of claim 4, wherein said first period of time is a beacon period.

6. The method of claim 1, further comprising the step of switching from a first communications channel of said first set of stations to a second communications channel of said second set of stations, wherein said first and second communications channels operate at different frequencies.

7. The method of claim 6, wherein said step of blocking comprises the step of transmitting a signal to said first set of stations to cause said first set of stations to enter into a virtual carrier sense mode for a duration of time.

8. The method of claim 7, wherein said signal comprises a value representing a length of said first period of time.

9. The method of claim 2, wherein said transmission of said first set of stations occurs at a 2.4 GHz band and said transmission of said second set of stations occurs at a 5 GHz band.

10. An access point comprising:
a transceiver, wherein said transceiver can operate at two or more radio frequency channels, and
a signal generator for generating a beacon frame signal.

11. The access point of claim 10, wherein each of said two or more radio frequency channels is associated with a unique basic service set.

12. The access point of claim 11, further comprising a controller to switch said transceiver from one to another of said two or more radio frequency channels at a time dependent on an occurrence of said beacon frame signal.

13. The access point of claim 10, wherein said two or more radio frequencies are based on an IEEE 802.11 protocol.

14. A method for servicing a first set of wireless stations operating on a first channel of an access point and a second set of wireless stations operating on a second channel of the access point, the method comprising the steps of:
transmitting, at a first time, a first frame from an access point to a first set of wireless stations via a first channel, wherein said first frame comprises duration data directing said first set of wireless stations to cease transmitting until a second time represented by said duration data; and
servicing a second set of wireless stations via a second channel of said access point for at least a part of a time period between said first time and said second time.

15. The method of claim 14, further comprising the steps of:
transmitting, at said second time, a second frame from said access point to said second set of wireless stations via said second channel, wherein said second frame comprises duration data directing said second set of wireless stations to cease transmitting until a third time represented by said duration data of said second frame; and
servicing said first set of wireless stations via said first channel of the access point for at least a part of a time period between said second time and said third time.

16. The method of claim 15, further comprising the step of transmitting a Delivery Transmission Indication Map (DTIM) frame prior to transmitting each of said first and second frames.

17. The method of claim 16, wherein said step of transmitting said DTIM frame occurs substantially simultaneously with a Target Beacon Transmission Time (TBTT) of said access point.

18. An access point comprising:
means for communicating with a first set of wireless stations via a first channel;
means for communicating with a second set of wireless stations via a second channel;
means for transmitting a first frame to said first set of wireless stations via said first channel at a first time, wherein said first frame comprises duration data directing said first set of wireless stations to cease transmitting until a second time represented by said duration data of said first frame; and
means for transmitting a second frame to said second set of wireless stations via said second channel at a second time, said second frame comprising duration data directing said second set of wireless stations to cease transmitting until a third time represented by said duration data of said second frame.

19. The access point of claim 18, wherein said access point is adapted to service said second set of wireless stations via said second channel for at least a part of a time period between said first time and said second time, and service said first set of wireless stations via said first channel of said access point for at least a part of a time period between said second time and said third time.

20. The access point of claim 18, further comprising means for transmitting a Delivery Transmission Indication Map (DTIM) frame prior to transmitting each of said first and second frames, wherein said transmission of said DTIM frame occurs substantially simultaneously with a Target Beacon Transmission Time (TBTT) of said access point.
